(19) United States
(12) Patent Application Publication
(10) Pub. No.: US 2004/0190437 A1
(43) Pub. Date: Sep. 30, 2004

(54) METHOD FOR MOVING A PICKUP HEAD MODULE TO THE INITIAL POSITION

(76) Inventors: Yu-Hung Sun, Taipei City (TW); Chih-Hao Chang, Taipei City (TW); Sen-Ming Chuang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,546

(22) Filed: Jul. 30, 2003

(30) Foreign Application Priority Data
Dec. 20, 2002 (TW) 091136878

(51) Int. Cl. G11B 15/64

(52) U.S. Cl. 369/300

(57) ABSTRACT

A method for moving a pickup head module to the initial position used in an optical disk drive without a touch sensor includes moving the pickup head module toward a spindle motor according to a gradually decreasing speed curve until the pickup head stops. When power is provided to the optical disk drive, recording a present address of a disk corresponding to the pickup head module after seeking and accessing the disk. Calculating a return distance according to the present address and the initial address of the disk and moving the pickup head module for the return distance toward the spindle motor.

### BACKGROUND OF INVENTION

1. Field of the Invention

The present invention relates to a method for moving a pickup head module to the initial position, and more specifically, to a method for moving a pickup head module to the initial position in an optical disk drive without a touch sensor.

2. Description of the Prior Art

Conventional optical disk drives typically have a touch sensor (e.g. a limit switch or an optical breaker) installed on a substrate for carrying a spindle motor. The function of the touch sensor is to detect whether a pickup head module,moved by a sledge motor, is able to move to a limit position at the end of its move range. Generally, the limit position is the initial position of the pickup head module, which is located in the part of the move range nearby the spindle motor. When the power is first switched on and a disk is placed in the optical disk drive, the pickup head module starts moving from the outer ring to the inner ring of the disk. When the pickup head touches the touch sensor, it has arrived at the initial position. Therefore, the touch sensor stops the sledge motor from moving when the pickup head is at the initial position, i.e. on the inner most ring of the disk.

After the pickup head module arrives at the initial position, the optical disk drive commences a start-up procedure. Afterwards, the pickup head module starts seeking and accessing the disk.

Because conventional optical disk drives require the touch sensor to ensure the pickup head module is at the initial position, additional costs are incurred during production.

Therefore, in order to reduce the production costs, the touch sensor is often omitted. In this situation, the optical disk drive cannot ensure the correct position of the pickup head module when the power is switched on. Additionally, the sledge motor provides too high a speed to the pickup head module, so that noises and even rack attrition could occur when the pickup head module moves to the initial position. The pickup head module may be damaged due to collision with the spindle motor and the overall quality of the optical disk drive is reduced.

### SUMMARY OF INVENTION

It is therefore a primary objective of the present invention to provide a method for moving a pickup head module to the initial position without a touch sensor. The pickup head module arrives at the initial position when power is first switched on and correctly returns to the initial position after seeking or accessing a disk.

Briefly summarized, a method for moving a pickup head module to the initial position used in an optical disk drive without a touch sensor includes moving the pickup head module toward a spindle motor according to a gradually decreasing speed curve until the pickup head stops. When power is provided to the optical disk drive, recording a present address of a disk corresponding to the pickup head module after seeking and accessing the disk, calculating a return distance according to the present address and the initial address of the disk, and moving the pickup head module for the return distance toward the spindle motor.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates the inner part of an optical disk drive without a touch sensor.

FIG. 2 illustrates the pickup head module returning to the initial position according to the present invention.

FIG. 3 illustrates a flowchart for the method of moving the pickup head module back to the initial position when the power of the optical disk drive is first switched on according to the present invention.

FIG. 4 illustrates a flowchart for the method of moving the pickup head module back to the initial position when the power of the optical disk drive is already switched on according to the present invention.

### DETAILED DESCRIPTION

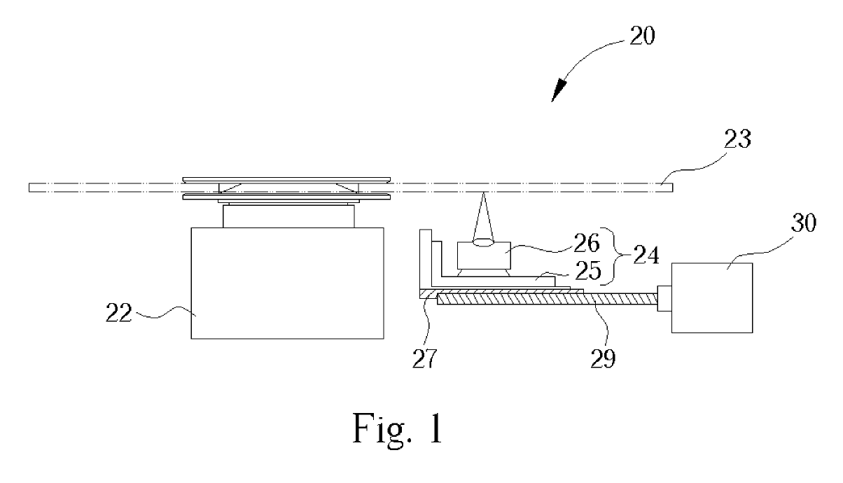

Please refer to FIG. 1 showing the inner section of an optical disk drive without a touch sensor. The optical disk drive 20 includes at least one spindle motor 22, a pickup head module 24, and a sledge motor 30. The spindle motor 22 is for controlling the spinning of a disk 23. The pickup head module 24 includes at least one sledge 25, a pickup head 26, and a rack 27. The sledge motor 30 keeps close contact with the rack 27 on the pickup head module 24 though a guide screw 29 and drives the pickup head module 24 by rotating the guide screw 29.

When the disk 23 is inserted, the pickup head module 24 is moved by the sledge motor 30 toward the spindle motor 22. However, since no touch sensor exists, it is unable to determine whether the pickup head module 24 has arrived at the initial position. In this situation, if the sledge motor 30 provides a constant speed to the pickup head module 24, when the pickup head module 24 moves from the position furthest from the spindle motor 22 to the initial position, rack 27 attrition and noises may occur due to the over-speed of the pickup head module 24. Moreover, the pickup head module 24 may be damaged due to collision with the spindle motor 22.

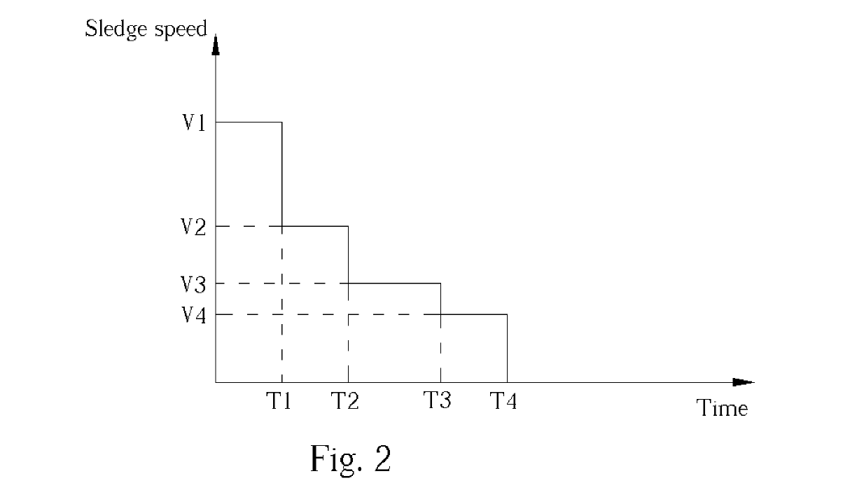

Because in an optical disk drive without a touch sensor, the pickup head module 24 is required to move back to the initial position when the power is switched on, the present invention provides a method for the pickup head module to move back to the initial position. Please refer to FIG. 2 showing the pickup head module speeds as it moves back to the initial position according to the present invention. When the power is switched on, the optical disk drive cannot ensure the position of the pickup head module, therefore, assuming that the pickup head module must moves the full distance to the initial position (i.e. from the most outer side to the most inner side, which is the total distance of the move range of the pickup head module), the sledge motor can provide various speeds to the pickup head module according to various times.

As shown in FIG. 2, since various speed are provided to the pickup head module, at time point T4, the total distance moved by the pickup head module is:

D=V1*T1+V2*(T2−T1)+V3*(T3−T2)+V4(T4−T3)

While determining the drive speed curve of the pickup head module, it is required to ensure the distance of the pickup head module moving at full speed at first, and decrease the curve gradually according to the distance. Even if the pickup head module is not at a position to move a full stroke when the power is first switched on, because the pickup head module is controlled with gradually decreasing speeds, the speed and the inertia are decreased when the pickup head module arrives the initial position and the accompanying rack attrition and noises are greatly reduced.

When the pickup head arrives at the initial position, a table of contents (TOC) of the disk can be found. Since address data is recorded, the optical disk drive is able to ensure the initial position of the pickup head module (i.e. the initial address of the disk), and control the pickup head module to seek and access the disk. Each time the optical disk drive completes seeking and accessing the disk, it is only required to record the present address of the disk. When the disk is to be removed, the optical disk drive simply calculates the distance between the present address and the initial address (return distance), and moves the pickup head module for the return distance so that the pickup head module returns to the initial position. The next time a disk is loaded in, the pickup head module is already at the initial position and ready for seeking and accessing.

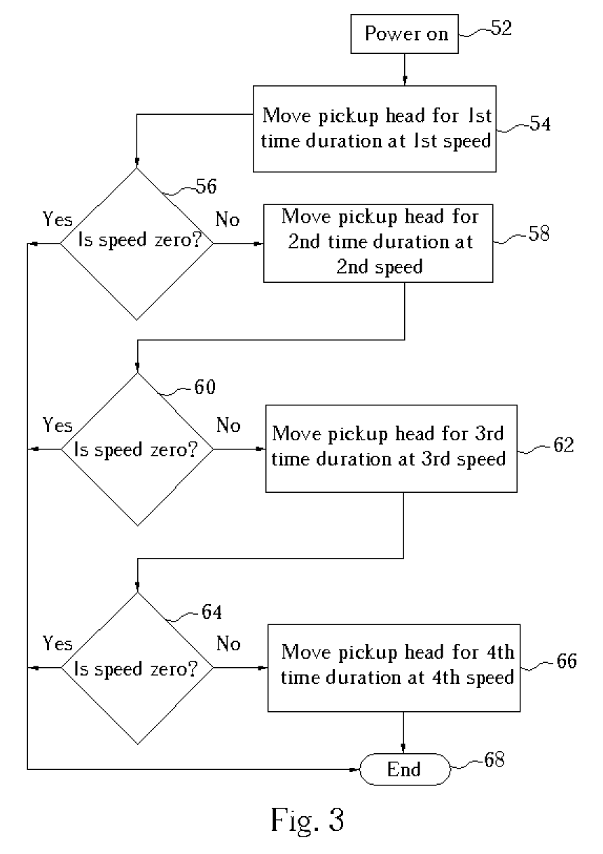

Please refer to FIG. 3 showing a flowchart of the method for moving the pickup head module back to the initial position when the power of the optical disk drive is first switched on according to the present invention. The flowchart includes the following steps:

Step 52 Switch on the power of the optical disk drive;

Step 54 Move the pickup head module for a first predetermined time duration at a first speed;

Step 56 Check whether the speed of the pickup head module is zero during the first predetermined time duration. If yes, proceed to Step 68, if no, proceed to Step 58;

Step 58 Move the pickup head module for a second predetermined time duration at a second speed;

Step 60 Check whether the speed of the pickup head module is zero during the second predetermined time duration. If yes, proceed to Step 68, if no, proceed to Step 62;

Step 62 Move the pickup head module for a third predetermined time duration at a third speed;

Step 64 Check whether the speed of the pickup head module is zero during the third predetermined time duration. If yes, proceed to Step 68, if no, proceed to Step 66;

Step 66 Move the pickup head module for a fourth predetermined time duration at a fourth speed;

Step 68 End.

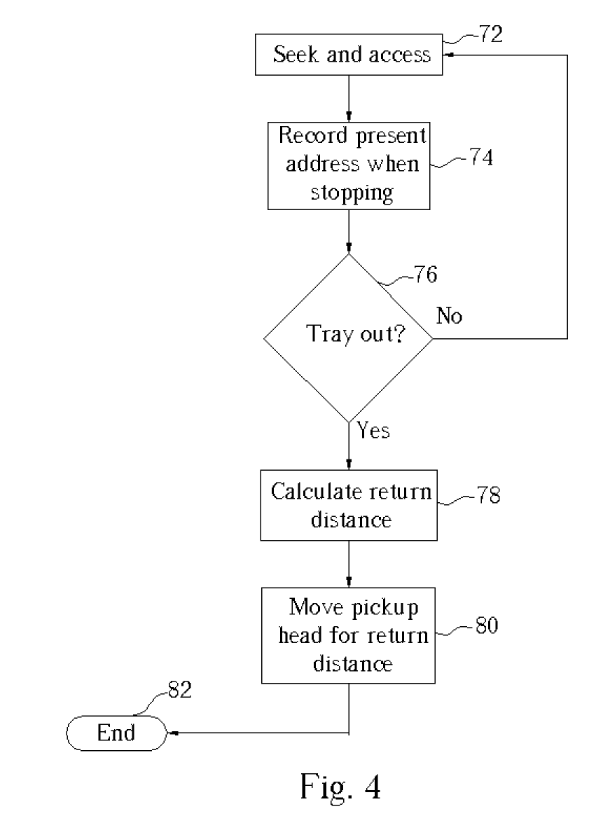

Please refer to FIG. 4 showing a flowchart of the method for moving the pickup head module back to the initial position when the power of the optical disk drive has already been switched on according to the present invention as follows:

Step 72 Seek and access the disk by the pickup head module;

Step 74 Record the present address of the disk when stopping the seek and access operation;

Step 76 Is the disk being removed (tray out)? If yes, proceed to Step 78, if no, proceed to Step 72;

Step 78 Calculate the return distance for the pickup head module according to the present address and the initial address of the disk;

Step 80 Move the pickup head module for the return distance in the direction from the outer ring to the inner ring of the disk;

Step 82 End.

Accordingly, in contrast to the prior art, it is an advantage of the present invention that without a touch sensor when the power of the optical disk drive is first switched on, the pickup head module moves toward the spindle motor (i.e. in the direction from outer ring to inner ring of the disk) using a gradually decreased speed. If the pickup head module stops, it has arrived at the initial position. Since the pickup head module is controlled using gradually decreasing speeds, even if the pickup head module is not at a position needing to move the full stroke when the power is first switched on, the speed and the inertia are decreased as the pickup head module arrives at the initial position so that the accompanying rack attrition and noises are greatly reduced.

In contrast to the prior art, it is another advantage of the present invention that without a touch sensor, after seeking and accessing the disk, when the disk is removed, it is only required to record the present address of the disk and calculate the return distance according to the present address and the initial address of the disk for the pickup head module, to move the pickup head module for the return distance back to the initial position.

Those skilled in the art will readily observe that numerous modifications and alterations of the method. Accordingly, the above disclosure should be construed as limited only by the metes and bounds of the appended claims.

What is claimed is:

1. A method for moving a pickup head module to an initial position for use in an optical disk drive without a touch sensor comprising the following step:
when power is provided to the optical disk drive, moving the pickup head module toward a spindle motor according to a gradually decreasing speed curve;
wherein the position where the pickup head stops is the initial position.

2. The method of claim 1 wherein the maximum distance the pickup head is able to move according to the speed curve is a full stroke.

3. A method for moving a pickup head module to an initial position for use in an optical disk drive without a touch sensor comprising the following steps:
recording a present address of a disk corresponding to the pickup head module after seeking and accessing the disk;
calculating a return distance according to the present address and an initial address of the disk; and
moving the pickup head module for the return distance in the direction from an outer ring to an inner ring of the disk.

4. The method of claim 3 wherein the pickup head module moves for the return distance when the disk is removed.

5. A method for moving a pickup head module to an initial position for use in an optical disk drive without a touch sensor comprising the following steps:
when power is provided to the optical disk drive, moving the pickup head module toward a spindle motor according to a gradually decreasing speed curve until the pickup head stops;
recording a present address of a disk corresponding to the pickup head module after seeking and accessing the disk;
calculating a return distance according to the present address and the initial address of the disk; and
moving the pickup head module for the return distance toward the spindle motor.

6. The method of claim 5 wherein the maximum distance the pickup head is able to move according to the speed curve is a full stroke.

7. The method of claim 5 wherein the pickup head module moves for the return distance when the disk is removed.
